(19) United States
(12) Patent Application Publication
(10) Pub. No.: US 2007/0043956 A1
(43) Pub. Date: Feb. 22, 2007

(54) System and methods that facilitate third party code test development

(75) Inventors: Ibrahim Khalil Ibrahim El Far, Bellevue, WA (US); Ivan Santa Maria Filho, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/207,213

(22) Filed: Aug. 19, 2005

(51) Int. Cl. G06F 12/14

(52) U.S. Cl. 713/189

(57) ABSTRACT

A generic testing framework is provided that allows components authored by third parties to be tested on a platform such as an operating system while mitigating exposure of implementation details of the third party components. In one aspect, a computerized test system is provided. The system includes at least one component test that operates on a component platform such as an operating system platform, for example. The component test can be specified in a generalized manner for sending and retrieving data from one or more third party components. At least one application programming interface (API) is provided that is associated with the third party component to enable data exchanges between the component test and the third party component on the component platform, where the API hides implementation details of the third party component.

### BACKGROUND

Verifying the quality of third party code often requires disclosure of third party intellectual property or confidential material with all the consequences of acquiring such knowledge. This is a common problem for applications that host third party code including but not limited to device drivers, hosted web-applications, or search components, for example. From a platform standpoint, certifying third party code requires either joint development of test cases in a cooperative model or the ability to inspect test cases developed by the third party. Typically, the person or group granting certificates define what test cases should be developed by the person or group requesting the certification. Expressing such test cases is a complex and error-prone exercise that balances precision and clarity. For instance, while formal mathematical formulas are precise describing a particular test, they are costly to define and often hard to understand. Description in colloquial English, on other hand, while easy to write, are often less precise.

To more clearly illustrate a particular testing scenario, consider a unified storage platform capable of storing, organizing, sharing, and searching all types of user data. This could include the ability to store both files and objects into a database, share data among applications and users, search and organize the data while preserving compatibility with older, file-based applications. To allow database-like queries and updates over the files it contains, applications usually store various types of file metadata. Metadata consists of data that may or may not be found inside the file and underlying file system and describe the contents of the file in question. The author and subject of a document are examples of metadata. The bit rate of a music file or the resolution and color depth of a picture are other examples. How much metadata is available for each file depends on the type of the file.

Each file format—such as jpeg, Media Video (e.g., wmv) or word processing documents—have different ways to store metadata. Some file formats obey open standards while others are proprietary and carry sensitive intellectual property for their owners. To acquire data from different file types as well as update the files keeping both file and database consistent, such applications often hosts third party code, where the generic name for such code is “metadata handlers” or MDH.

Metadata handlers or MDHs pose a number of risks to the user experience, from reliability to security holes. To try to minimize problems to its customers, some software vendors define a certification process for MDHs. A substantial portion of the certification process is the design, execution, and validation of adequate certification tests. Desirable requirements of certification test support in a collaborative workflow model include: the certification framework should not require the knowledge of third party implementation details such as: Proprietary file formats; Proprietary file access API; Third party file metadata handler; Details of how data is mapped from file to application data store; and Details of how to compare data obtained from file to data obtained from the store, for example. The certification framework should not require third party to supply specific instances of data such as Files or Values of file metadata. Also, the certification framework should be able to leverage the same tests for any file metadata handler a third party can author and should be able to supply instances of data to drive each certification test.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A testing framework is provided that allows platform code developers to interact with third party code developers while mitigating exchange of sensitive or confidential information. More specifically, a generic testing platform and interface is provided where third party code developers implement an abstract interface that allows code written for a platform such as an operating system to exercise the third part code without being apprised of implementation details in the code. In general, verifying the quality of third party code often requires disclosure of third party intellectual property having the associated consequences of acquiring such knowledge which can include leakage of proprietary data. This is a common problem for applications that host third party code including but not limited to device drivers, hosted web-applications, or search components, for example. Various systems and methods are provided to precisely express test cases while minimizing disclosure of third party intellectual property for certification test purposes. This includes providing an interface and definition of a set of certification tests in an abstract manner that can be reused with each test including file metadata handlers, for example, where the tests are specified at a level of abstraction that allow them to be independent of specific data types. At least one mechanism (e.g., certification driver interface) is provided for querying for file metadata handler information or other data required to run these respective tests. Such data can include: platform type data to which the file corresponds; file extensions a file metadata handler supports; abstract enumerations of keys to metadata the file metadata handler operates with; methods for creating files the file metadata handler supports; methods for reading and writing file metadata from and to files as well as from and to a respective data store; and/or methods for comparing metadata from the store against metadata from a given file.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating an automated testing system.

FIGS. 2-4 illustrate an automated testing process.

FIG. 5 illustrates example test interfaces.

FIG. 6 illustrates an example automated component testing system.

FIG. 7 illustrates example metadata for automated testing.

FIG. 8 is a schematic block diagram illustrating a suitable operating environment.

FIG. 9 is a schematic block diagram of a sample-computing environment.

### DETAILED DESCRIPTION

A generic testing framework is provided that allows components authored by third parties to be tested on a platform such as an operating system while mitigating exposure of implementation details of the third party components. In one aspect, a computerized test system is provided. The system includes at least one component test that operates on a component platform such as an operating system platform, for example. The component test can be specified in a generalized manner (e.g., non-specific to third party or platform implementation) for sending and retrieving data from one or more third party components. At least one application programming interface (API) is provided that is associated with the third party component to enable data exchanges between the component test and the third party component on the component platform, where the API hides implementation details of the third party component. In this manner, platform developers can test outside code developments in an abstract way without being exposed to implementation details of such code developments.

As used in this application, the terms “component,” “object,” “interface,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

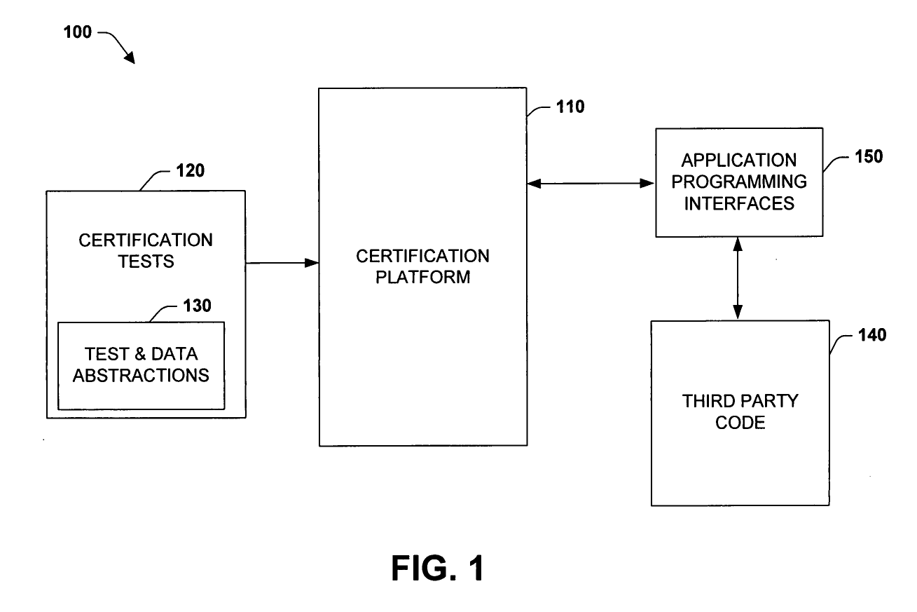

Referring initially to FIG. 1, an automated component testing system 100 is illustrated. The system 100 includes a certification platform 110 that is designed to be compatible with a plurality of components outside the platform. For instance, the platform 110 could be an operating system or other large component where the components under test can include substantially any type of computer component such as drivers, software, network components, input/output (I/O) components, buses or controllers, memory components, processor components, databases, peripheral components, and so forth. In general, one or more certification tests 120 are authored for the platform 110. The tests 120 are designed and constructed with a layer of abstraction at 130 for the tests and data that may be employed for the tests. Such abstraction 130 shields outside components such as third party code 140 from having to know or provide details to the certification tests 120. In this system 100, the third party code 140 is designed by developers outside the platform 110. One or more interfaces 150 are provided to enable the third party code to be exercised and tested by the platform 110 and associated tests 120 in a generic manner. In other words, the interfaces 150 allow the third party components 140 to be tested by the certification tests 120 without being exposed to implementation details of the third party code.

The system 100 provides a testing framework that allows platform code developers to interact with third party code developers while mitigating exchange of sensitive or confidential information within the platform 110 or third party code 140. More specifically, a generic testing platform and interface 150 is provided where third party code developers implement an abstract interface that allows certification code 120 written for the platform 110 to exercise the third part code 140 without being apprised of implementation details in the code. In general, verifying the quality of third party code often requires disclosure of third party intellectual property which can include leakage of proprietary data. This is a common problem for applications (e.g., operating system platforms) that host third party code 140 including but not limited to device drivers, hosted web-applications, or search components, for example. Various systems and methods are provided to precisely express test cases while minimizing disclosure of third party details for certification test purposes. This includes providing an interface 150 and definition of a set of certification tests 120 in an abstract manner that can be reused with each test including file metadata handlers, for example, where the tests are specified at a level of abstraction 130 that allow them to be independent of specific data types.

At least one interface such as a certification driver interface is provided for querying for file metadata handler information or other data required to run these tests 120. Such data can include: platform type data to which the file corresponds; file extensions a file metadata handler supports; abstract enumerations of keys to metadata the file metadata handler operates with; methods for creating files the file metadata handler supports; methods for reading and writing file metadata from and to files as well as from and to a respective data store (not shown); and/or methods for comparing metadata from the store against metadata from a given file.

In general, the system 100 provides the ability to express tests in a precise manner while preserving third party intellectual property or confidential information. This includes the use of file metadata handler-agnostic tests in certification of file metadata handlers, for example. Also, this includes the use of data type-agnostic tests in certification of file metadata handlers. The definition of the interface 150 includes programmatically mapping arbitrary or third party data to platform data via file metadata handlers. The definition of the interface 150 generally supplies all file-metadata handler characteristics to the certification platform 110 without exposing third party implementation details.

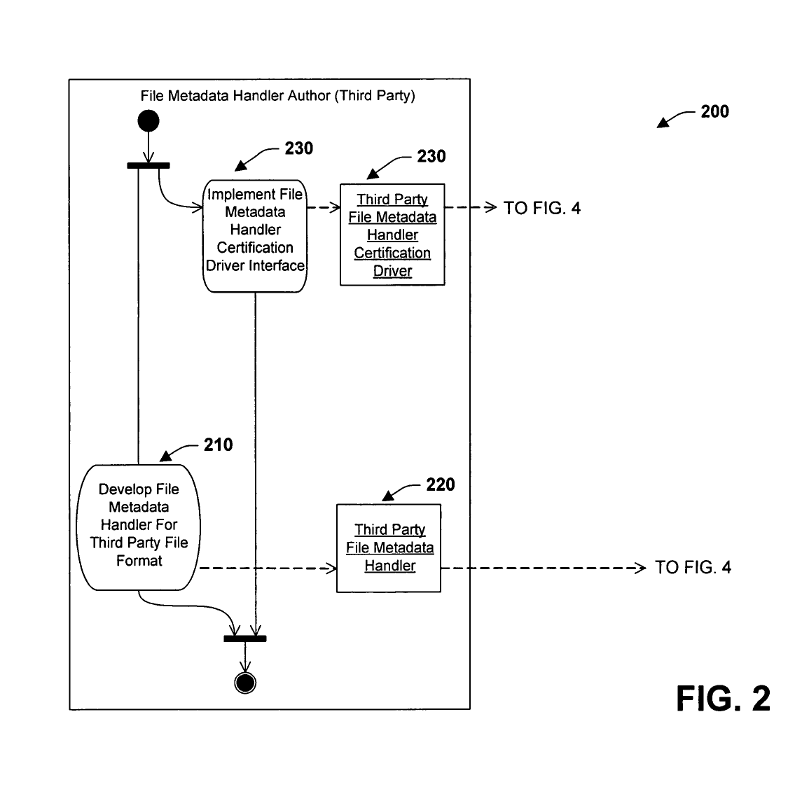

Referring now to FIGS. 2-4, an automated testing process is illustrated. While, for purposes of simplicity of explanation, the process is shown and described as a series or number of acts, it is to be understood and appreciated that the subject process is not limited by the order of acts, as some acts may, in accordance with the subject process, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject process.

FIGS. 2-4 illustrate a process for a third party developer, a system platform, and a test author to interact in an abstract manner. FIG. 2 illustrates a metadata handler process 200 for third party component developers. In general, this process 200 applies to the third party developer who: develops a file metadata handler; develops an implementation of a certification driver interface; and submits both handler and interface implementation to a platform developer for independent certification. Proceeding to 210, a file metadata handler or component is developed with respect to a third party format. The metadata handler is then passed to a certification platform at 220. At 230, an implementation of a file metadata certification driver interface is created. This is then passed to a certification system at 240.

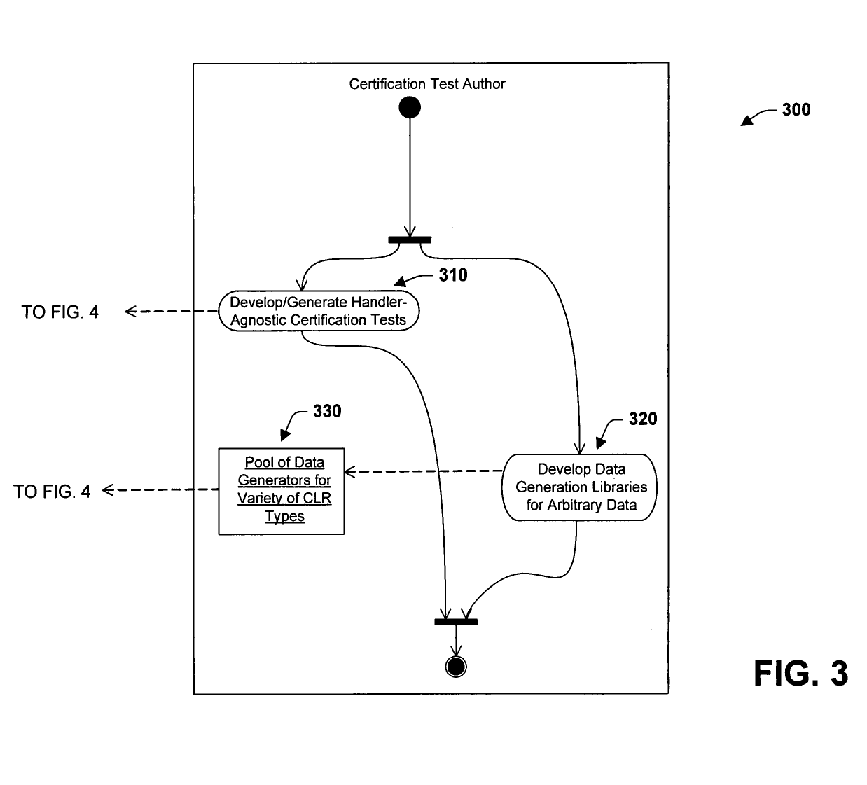

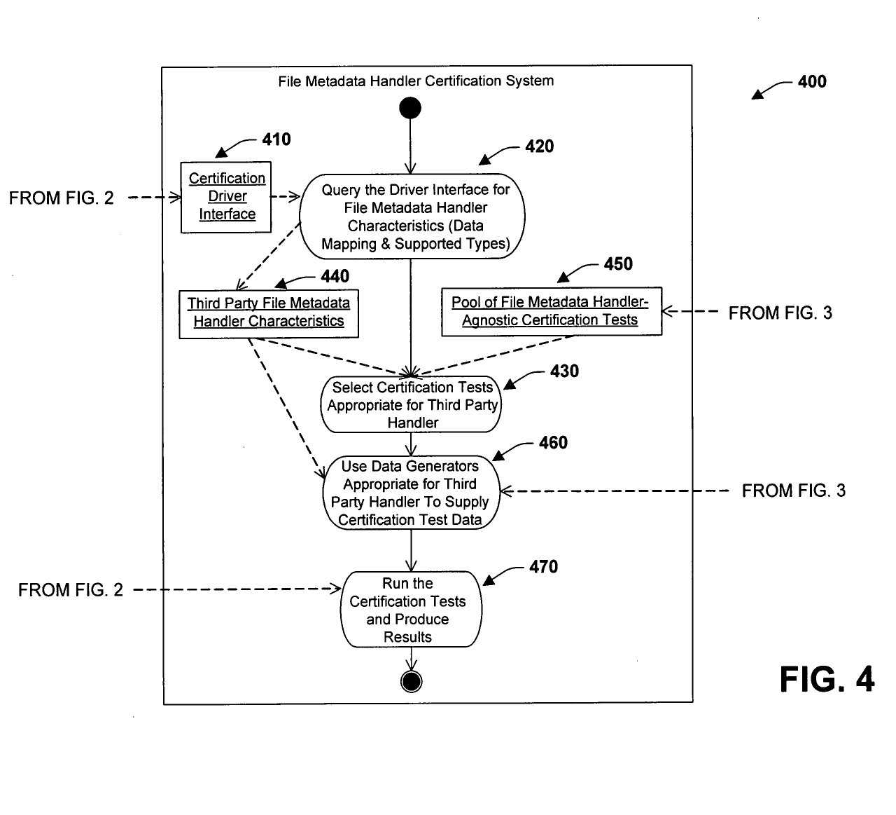

Proceeding to FIG. 3, a certification authoring process 300 is provided for a file metadata handler. In general, a certification test author: develops a set of tests that are handler and type agnostic and that certify the handler upon successful execution. The author develops a set of data generators that can generate instances of arbitrary data types to driver the certification tests. This also, includes submitting these tests and data generators to the certification framework. Proceeding to 310, one or more agnostic certification tests are developed or generated by a certification test author. These tests are passed to the certification system process which is described in more detail below with respect to FIG. 4. At 320, one or more data generation libraries are developed for various types of arbitrary data. At 330, a pool of data generators are passed to the certification system test process described in more detail below with respect to FIG. 4.

Proceeding to 400 of FIG. 4, a certification system test process is provided. The certification system 400 provides a testing platform where component testing authored in FIG. 3 can be applied to third party development code via the interfaces described in FIG. 2. In general, this testing can include: queries for the certification driver interface for substantially all file metadata handler information employed for running certification tests. The tests can be tailored to individual file metadata handlers using data generators and the file metadata handler information previously queried. The process 400 also runs various certification tests and produces testing results that can be reported over local or remote networks to various systems for further analysis.

Proceeding to 410, a certification driver interface is received from the process described in FIG. 2. At 420, a driver interface is queried for file metadata handler characteristics. This can include data mapping information and data type information supported by a respective third party component. At 430, one or more third party metadata handler characteristics 440 and a pool of file metadata handler agnostic certification tests 450 (From FIG. 3), are processed by selecting one or more certification tests that are suitable for the respective third party handler. For instance, if a device driver interacts with various systems buses, certification tests may be selected to cause activities on the respective buses during the given device driver tests in one example. Other aspects could include generating various events and interrupts to exercise a given driver. At 460, one or more data generators (From FIG. 3) are employed to allow third party handlers to supply certification test data. At 470, one or more certification tests are run and tests results are produced and/or stored for further analysis.

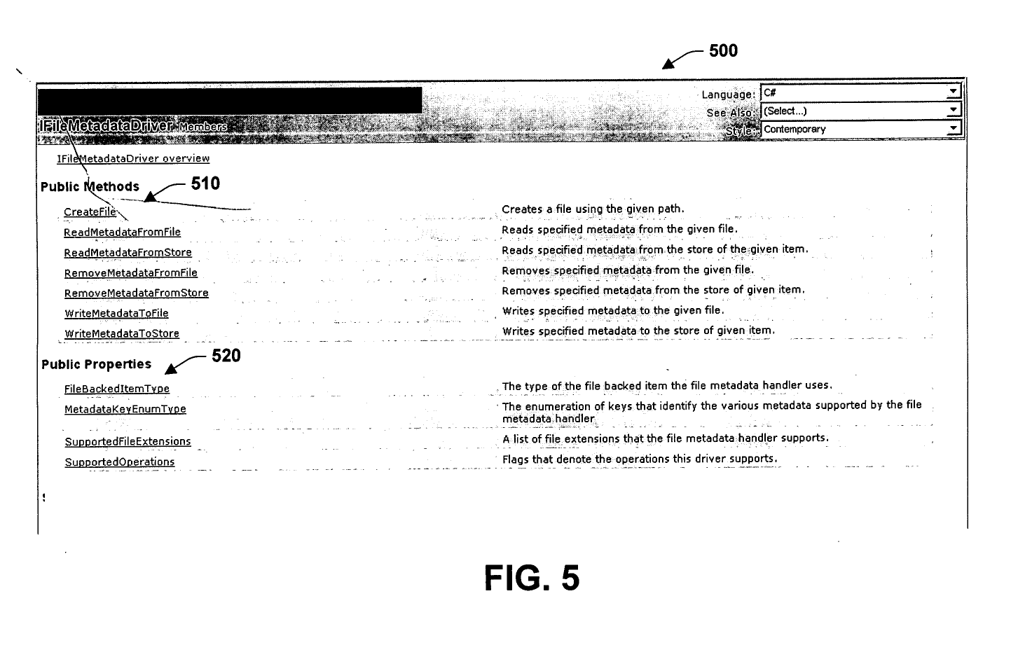

Referring to FIG. 5, example test interfaces 500 are illustrated that can be employed with the testing and third party components described above. The interfaces illustrated at 500 represent one or more example implementations of the above noted certification driver interfaces. At 510, one or more methods can be provided. These include create file interfaces, a read metadata from file or from data store interface. A remove metadata from file or store interface along with a write metadata to a file or store. The interfaces 510 can provide such functional aspects as: creating a file using a given path; reading specified metadata from a given file; reading specified metadata from the store of a given file; removing specified metadata from a given file; removing specified metadata from the store of a given file; writing specified metadata to a given file; and writing specified metadata to the store of a given file.

Along with the methods 510, various properties can be specified at 520. These include file backed item type properties that specify the type of a file backed item a file metadata handler employs during testing. Another property 520 is a metadata key enumeration type that specifies enumeration keys that identify various metadata supported by the file metadata handler. Still yet another property includes a supported file extension that specifies a list of file extensions that a file metadata handler supports. Another property includes a supported operations property that specifies flags that the respective operations supported by a given driver. As can be appreciated, other interfaces 510 and/or properties 520 can be specified.

In one example, a file metadata interface or class can be defined as follows: public abstract class FileMetadataDriver: IFileMetadataDriver. In general, a class that derives from the file metadata class is typically expected to be written for each file format. In order to illustrate how to use this class, consider the following example:

A user owns file format FOO. Files of format FOO have the file extension “.foo”. The user would like to store two properties of FOO files in the store: FilePropertyA and FilePropertyB. Also, the user would like to store the two properties as ExamplePropertyA and ExamplePropertyB of FooItem, defined in the Bar schema. An application programming interface (API) to the Bar schema is in the System.Storage.Bar.dll assembly. Thus, the user writes a file metadata handler to perform property promotion/demotion, and now they desire to certify that it works well with the file metadata handling infra. In order to write a FileMetadataDriver, the user could write the following example code:

```
            // Enumeration of metadata keys.
          //
            [Flags]
            internal enum FooMetadataKeys
            {
              // Refers to all properties.
              //
              All = 0xFF,
              // Denotes no properties.
              //
              None = 0x00,
              // FilePropertyA or ExamplePropertyA
              //
              A = 0x01,
              // FilePropertyB or ExamplePropertyB
              //
              B = 0x02
            }
    // Required implementation to use certification test tool.
      //
      public FooFileMetadataDriver : FileMetadataDriver
      {
        // Default constructor. Specifies all required information
        // that the base class needs to do its work.
        //
        public FooFileMetadataDriver( )
          :base(
            // Specify the type of the item to which each FOO file
            // is promoted.
            //
            typeof(System.Storage.Bar.FooItem),
            // Specify the enumertion type that enumerates all the
            // keys to file metadata.
            //
            typeof(FooMetadataKeys),
            // Specify the file extensions supported by the file
            // metadata handler.
            //
            new string[ ] { “foo” },
            // Specify the file metadata operations supported by
            // the file metadata handler.
            //
            FileMetadataOperations.All,
            // Specify the functions that read properties from file.
            //
                new object[ ] {
              FooMetadataKeys.All,
              new FileMetadataReader(ReadAnyMetadataFromFile)
            },
            // Specify the functions that write properties to file.
            //
            new object[ ] {
              FooMetadataKeys.All,
              new FileMetadataWriter(WriteAnyMetadataToFile)
            },
            // Specify the functions that read properties froms store.
            //
            new object[ ] {
              FooMetadataKeys.All,
              new StoreMetadataReader(ReadAnyMetadataFromStore)
            },
            // Specify the functions that write properties to store.
            //
            new object[ ] {
              FooMetadataKeys.All,
              new StoreMetadataWriter(WriteAnyMetadataToStore)
            }
          )
              // Reads any property (A or B) from the store.
        //
        private object ReadAnyMetadataFromStore(Item item, object
metadataKey, object[ ] arguments)
        {
          ...
        }
        // Reads any property (A or B) from the file.
        //
        private object ReadAnyMetadataFromFile(string filePath, object
metadataKey, object[ ] arguments)
        {
          ...
        }
        // Writes any property (A or B) to the store.
        //
        private object WriteAnyMetadataToStore(Item item, object
metadataKey, object[ ] arguments, object metadata)
        {
          ...
        }
        // Writes any property (A or B) to the file.
        //
        private object WriteAnyMetadataToFile(string filePath, object
metadataKey, object[ ] arguments, object metadata)
        {
          ...
        }
      }
```

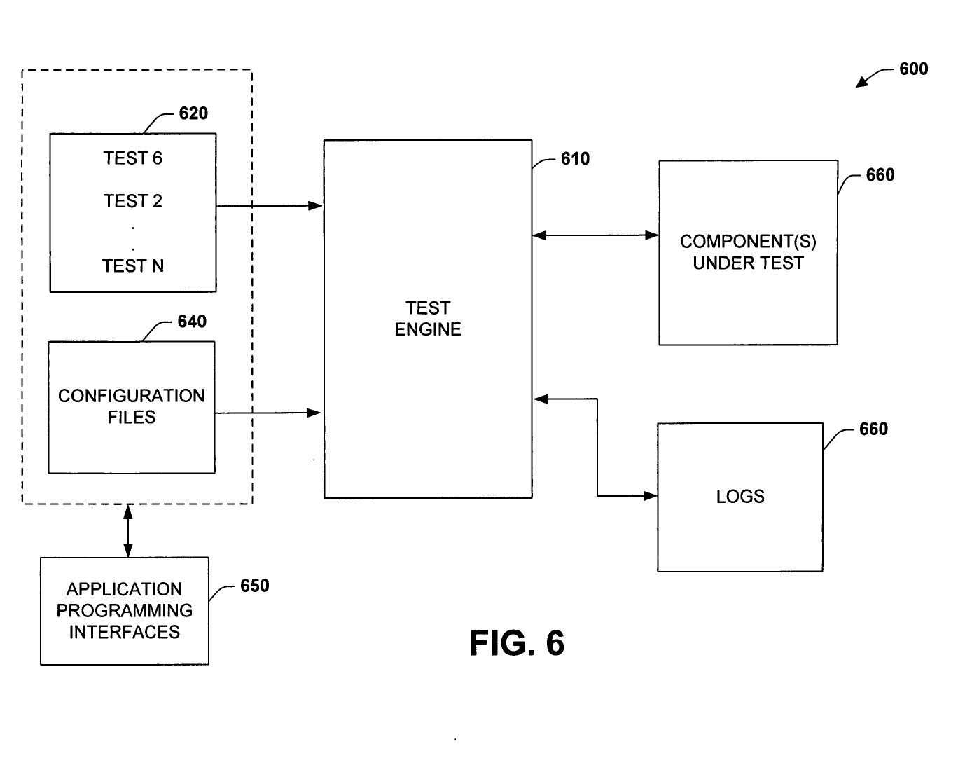

FIG. 6 illustrates an example test automated component testing system 600. The system 600 includes a test engine 610 that executes a test subset 620 on one or more components under test 630. As noted above, the components under test 630 can include substantially any type of computer component such as hardware, software, network components, input/output (I/O) components, buses, memory, processors, databases, peripherals, and so forth. Also, the test subset 620 can include zero or more tests to be executed on the test components 630. A configuration file 640 is provided to guide the execution and ordering of tests and in some cases whether or not one subset of tests 620 is executed during the execution of other test subsets 620. To facilitate interactions and specifications of the test subsets 620 and configuration files 640, one or more application programming interfaces 650 (APIs) are provided to serve as a guide for implementing new tests and to mitigate disruption of previously written tests 620. A log or database component 660 can be provided to facilitate publishing and recording of desired test results, where the log can be served locally and/or remotely such as across the Internet for example.

Unlike other loosely defined test frameworks, where developers write test code in any manner they want, with little guidance as to structure, little attention to quality basics, and little unification of approach as to how the tests are ultimately executed, the system 600 imposes a structure and guideline requirement for testing via the APIs 650. In terms of requirements, writing test components should generally be efficient and address several problems at once, if possible. Specifically, without changing an existing code base or test subset 620, a developer should be able to run the same tests with any user privileges, even if some test initialization or cleanup may require administrative privileges. They should also be able to run the same tests without validation to assess performance of a system under stress, as the additional validation code can hinder a better assessment of the resilience of the software under test. Other features include running the same tests under faulty conditions, with minimal additional code. Alternate validation code that expects specific errors or exceptions can be swapped or switched in place of the original validation code that evaluates the test results under normal conditions.

In terms of structure, the developer should also be able to specify and distinguish between key phases of testing in order to have a fine grain control over what to execute, when to execute it, how to handle failures in each phase, optionally replacing one of the phases, and satisfying other aforementioned goals. For example, these phases can include set up, execution (main object of test code), validation (main mechanism of determining whether results are suitable), publishing (mechanism for copying or post-processing logs), and a clean up phase. As can be appreciated, other phase can be provided if desired depending on the desired testing granularity.

Other aspects to the system 600 include the ability to define a workflow of execution that determine how and when tests are executed, how/when test groups are generated/enumerated and their tests executed, and how/when test modules (physical groupings of tests) are generated/enumerated and their groups/tests processed/executed. The APIs 650 and configuration files 640 allow replacing substantially any component of the system 100 while mitigating failures in other test subsets that choose to abide by imposed contracts of the APIs 650 in a different manner. To meet these and other goals, a set of lightweight interfaces 650 are provided that are easy to use by developers along with a set of convenience default implementations of these interfaces. Beyond basic contracts imposed by the interfaces 650, developers are generally under no other system constraints.

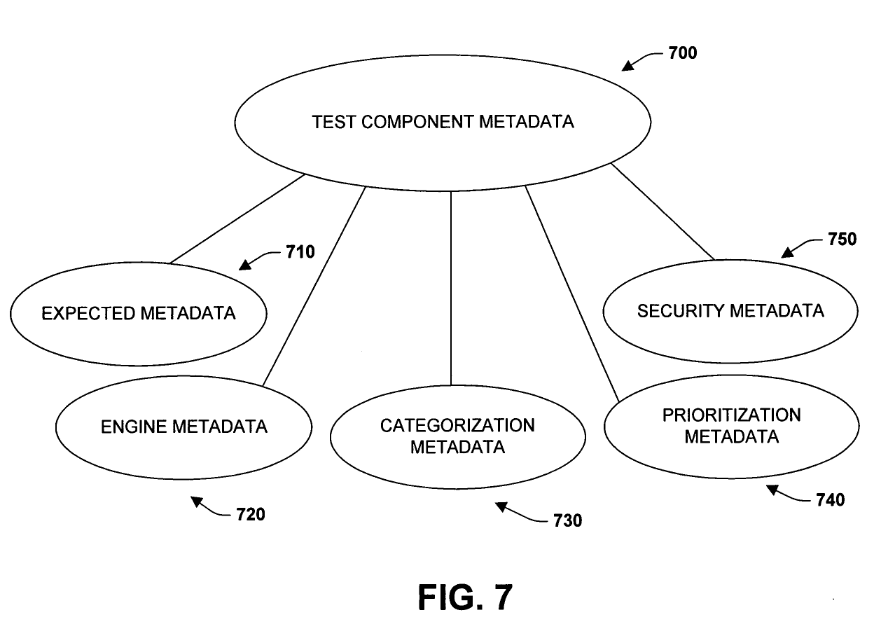

Referring to FIG. 7, example test component metadata 700 is illustrated that can be employed with a test execution engine. For convenience, test components are often decorated with metadata. For example, test groups have names and tests have priorities. Test modules are test components that do have metadata; they are considered mere physical organizations of tests and test groups without any additional meaning attached.

The test execution engine or certification platform expects certain metadata to be supplied by test component authors. For example, a test author should supply its name. Metadata is the primary mechanism for filtering interesting tests from a large pool of tests. Metadata may also be used by other libraries to organize and sort tests and test results. The test execution engine also supplies metadata that describes the test components it requires to run. Such metadata is stored in the global context. For example, the test execution engine may communicate to the generator of a test group that only functional tests with a given priority are going to be executed.

Proceeding to 710, Expected Metadata is described. This can include a Name, a string unique relative to a test group; an Area, a string; an Author, a string; an Associated bugs, a string; a Priority, an enumerated value; a Category, an enumerated value; and/or a User group options, an enumerated flag value. User group options define the user groups the privileges of which are employed in order for the test to successfully execute. At 720, engine supplied metadata may include: a Test Name; a Group Name; an Author; Associated bugs; a Priority; a Category; or User group options.

At 730, Categorization Metadata is considered. This is used to specify the category of a test or specify categories of a test to be selected for execution.

```
public enum TestCategory : byte
{
    AllCategories = 0xFF,
    Functional  = 0x1,
    Performance = 0x2,
    Stress = 0x4
}
```

In the following example, only functional tests are generated. The category of tests to be generated is specified in a global context using the appropriate metadata keys.

```
    public class MyFunctionalTestGroup : ITestGroup
    {
      ...
      public GenerateTests(IDictionary context)
      {
        // Generate tests only if functional tests are required.
        If ((TestCategory)context[MetadataKeys.Category] ==
TestCategory.Functional)
        {
          // Generate the functional tests.
        }
      }
      ...
    }
```

Proceeding to 740, Prioritization Metadata is provided. This is used to specify the priority of a test or specify the priorities of a collection of tests.

| public enum TestPriority : byte | |
|---|---|
| { | |
| AllPriorities = 0xFF, | |
| P0 | = 0x01, |
| P1 | = 0x02, |
| P2 | = 0x04, |
| P3 | = 0x08 |
| } | |

In the example, the priority of a test is used to determine whether to write something to an output device or console.

```
    public class MyTest : ITest
    {
      ...
      void Setup(IDictionary context)
      {
        ...
        if ((TestPriority)context[MetadataKeys.Priority] ==
TestPriority.P0)
        {
          Console.WriteLine(“The test is a P0 test.”);
        }
        ...
      }
      ...
    }
```

At 750, Security Metadata is provided. This is used to specify a collection of user groups, for example to run a given collection of tests under the privileges of different users that are members of a number of groups.

```
public enum UserGroupOptions : ushort
{
    AllGroups  = 0xFFFF,
    Administrators  = 0x0001,
    BackupOperators  = 0x0002,
    Guests  = 0x0004,
    NetworkConfigurationOperators = 0x0008,
    PowerUsers  = 0x0010,
    RemoteDesktopUsers  = 0x0020,
    Replicator  = 0x0040,
    Users  = 0x0080,
    DebuggerUsers  = 0x0100,
    HelpServicesGroup  = 0x0200,
    OfferRemoteAssistanceHelpers = 0x0800,
}
```

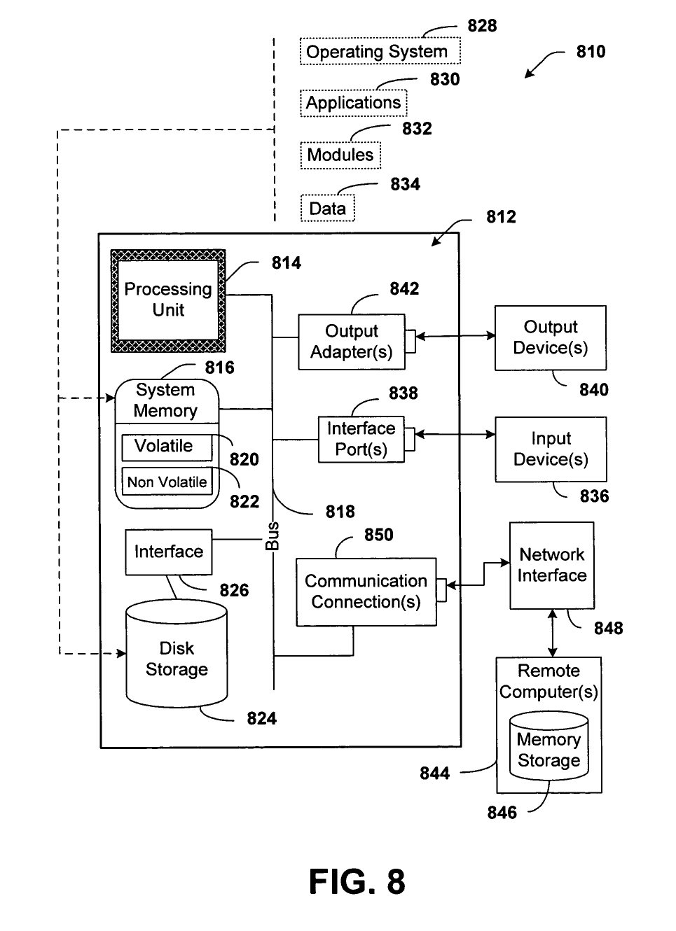

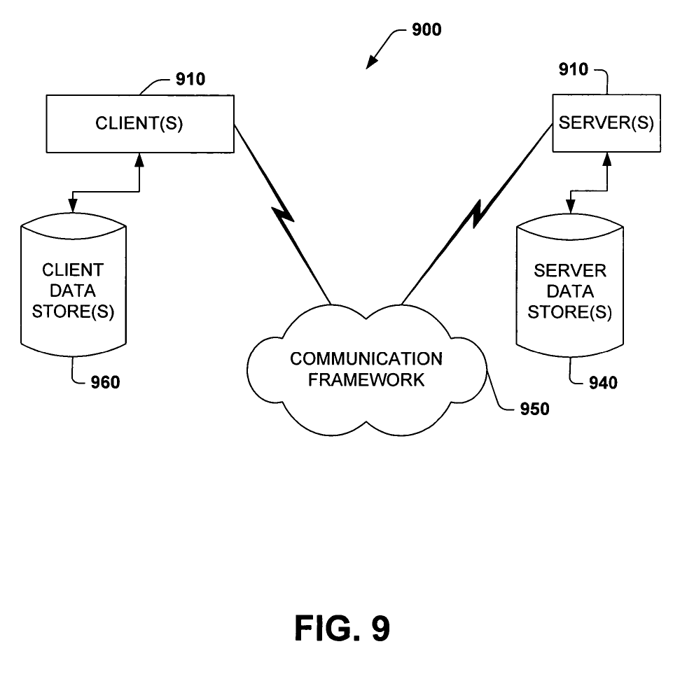

In order to provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 8, an exemplary environment 810 for implementing various aspects described herein includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that various components described herein can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

FIG. 9 is a schematic block diagram of a sample-computing environment 900 that can be employed. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the components described herein, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computerized test system, comprising:
at least one component test operative on a component platform, the component test specified in a generalized manner for sending and retrieving data from one or more third party components; and
at least one application programming interface (API) associated with the third party component to enable data exchanges between the component test and the third party component on the component platform, the API hides implementation details of the third party component.

2. The system of claim 1, further comprising a component to map data in one format to data in a subsequent format.

3. The system of claim 1, the component test further comprises a metadata handler to process data from the third party component.

4. The system of claim 3, the third party component includes a third party application programming interface (API) to interact with the component test.

5. The system of claim 4, the API enables a file metadata handler to be queried for test information to run a component test.

6. The system of claim 5, the test information includes a component platform type for which a file corresponds.

7. The system of claim 5, the test information includes one or more file extensions that are supported by a file metadata handler.

8. The system of claim 5, the test information includes an abstract enumeration of keys to metadata that is processed by a file metadata handler.

9. The system of claim 5, further comprising at least one abstract method for creating files that are supported by a file metadata handler.

10. The system of claim 5, further comprising at least one method for reading and writing metadata to and from files or a data storage component.

11. The system of claim 10, further comprising a component to compare metadata from a data store to file metadata.

12. The system of claim 1, further comprising a pool of data generators to support a plurality of data types.

13. The system of claim 1, further comprising at least one type of metadata for test, the metadata includes default metadata, test engine metadata, categorization metadata, prioritization metadata, and security metadata.

14. The system of claim 1, further comprising a component to select a certification test for a given third party component handler.

15. The system of claim 1, further comprising to store test information for the component platform and to make available test results to local or remote analysis systems.

16. The system of claim 1, further comprising a computer readable medium having computer readable instructions stored thereon for implementing the component test or the API.

17. A computerized testing method, comprising:
defining a metadata interface for a third party driver;
defining at least one component test for an operating platform;
installing the driver on the operating;
automatically executing the component test for the third party driver via the metadata interface; and
storing results for the component tests on the operating platform.

18. The method of claim 17, further comprising submitting a file handler and an interface implementation to the operating platform for certification.

19. The method of claim 18, further comprising employing one or more properties with the interface implementation, the properties include at least one of an item type, an enumeration type, a file extension type, and a supported operations type.

20. A system to facilitate automated component testing, comprising:
means for interfacing to a third party component;
means for exercising the third party component with an operating system;
means for abstracting the third party component from the operating system; and
means for mapping data between the third party component and at least one certification test authored for the operating system
